(19) United States
(12) Patent Application Publication
(10) Pub. No.: US 2016/0133023 A1
(43) Pub. Date: May 12, 2016

(54) METHOD FOR IMAGE PROCESSING, PRESENCE DETECTOR AND ILLUMINATION SYSTEM

(71) Applicant: OSRAM GmbH, Munich (DE)

(72) Inventor: Herbert Kaestle, Traunstein (DE)

(21) Appl. No.: 14/936,717

(22) Filed: Nov. 10, 2015

(30) Foreign Application Priority Data
Nov. 11, 2014 (DE) 10 2014 222 972.3

(51) Int. Cl. G06T 7/00; G06K 9/20; G06K 9/62

(52) U.S. Cl. CPC G06T 7/0044; G06K 9/6202; G06K 9/6267; G06K 9/2027

(57) ABSTRACT

A method for image processing is provided. The method includes acquiring at least one object in a recorded image, determining an orientation of the at least one acquired object, and classifying at least one acquired object, the orientation of which was determined, by comparison with a reference. The orientation is determined by calculating at least one moment of inertia of the acquired object.

### CROSS-REFERENCE TO RELATED APPLICATION

This application claims priority to German Patent Application Serial No. 10 2014 222 972.3, which was filed Nov. 11, 2014, and is incorporated herein by reference in its entirety.

### TECHNICAL FIELD

Various embodiments relate to a method for image processing, in which at least one object is acquired in a recorded image, an orientation of the at least one acquired object is determined and at least one acquired object, the orientation of which was determined, is classified by comparison with a reference. By way of example, various embodiments are applicable as a presence detector and in illumination systems with at least one such presence detector, e.g. for room lighting and outside lighting.

### BACKGROUND

Passive IR sensitive (“PIR”) detectors which react, usually differentially, with simple signal acquisition to object movements in the field of view thereof are known for presence recognition. Here, common PIR detectors usually use PIR sensors on the basis of pyroelectric effects, which only react to changing IR radiation. That is to say, a constant background radiation remains unconsidered. Such PIR sensors—technically in conjunction with Fresnel zone optics—can only be used as motion detectors and cannot be used for detecting a static presence. However, this is insufficient for an advanced, at least also static object recognition and/or object classification. A further disadvantage of the PIR detectors consists of these having a relatively large installation volume due to the IR-capable Fresnel optics. Moreover, a relatively high false detection rate emerges due to the typically low angle-resolution and range. As a result of the pure motion sensitivity, if the motion detector is activated within the scope of an illumination system, a person must make themselves noticeable by clear gestures so that the illumination system is activated or remains active.

A further group of known motion detectors includes active motion detectors, which emit microwaves in the sub-gigahertz range or else ultrasonic waves in order to search through the echoes thereof for Doppler shifts of moving objects. Such active motion detectors are also typically only used as motion detectors and not for the detection of a static presence.

Furthermore, a camera-based presence recognition using a CMOS sensor is known. The CMOS sensor typically records images in the visible spectral range or acquires corresponding image data. The CMOS sensor is usually coupled to a data processing apparatus, which processes the recorded images or image data in respect of a presence and classification of present objects.

For the purpose of an object recognition with CMOS sensors, it is known to at first release at least one object in the image or in the image data from a general background and subsequently to analyze the object by a feature-based object recognition or pattern recognition and classify it in respect of the properties thereof, and therefore to recognize it. For the fields of application of presence recognition and general illumination, objects which are similar to a person or a human contour are mainly of interest, in order e.g. to emit a corresponding notification signal to the light management system in the case of a positive result. A conventional method for the feature-based object recognition is the so-called “normalized cross correlation analysis”, in which an object released from the background and therefore acquired or “segmented” is compared with a suitable reference image by way of statistical 2D correlation analyses and the result of the comparison is used as a characteristic similarity measure for the purposes of a decision relating to the presence of a person.

However, a direct arithmetic comparison between the acquired object and the reference image cannot be used as the similarity measure in image processing since, for this purpose, the two comparison images would need to have the same image values such as exposure, contrast, position and perspective, which is not the case in practice. Thus, the normalized cross correlation analysis (also referred to as an NCC) is often used in practice. The normalized cross correlation analysis uses statistical methods to evaluate absolute differences between an original image (in this case: the acquired, released object or the associated image region) and the reference image, while absolute sums between the original image and the reference image can also still be evaluated in a complementary manner by way of a convolution analysis. However, a precondition for the successful application of the normalized cross correlation analysis is the same angle arrangement or orientation of the original image and of the reference image. Typically, similar patterns or images with a mutual angle deviation of up to +/−10° can be determined sufficiently well with the normalized cross correlation analysis.

In general illumination, the objects in the monitored region can have any orientation, particularly in the case where the CMOS sensor is assembled on the ceiling. The application of the normalized cross correlation analysis for pattern recognition in the case of an unknown alignment of the acquired object can be brought about using a direct solution approach, in which the reference image is rotated step-by-step in all angle positions and the comparatively computationally intensive normalized cross correlation analysis is carried out for each angle position for the purposes of checking similarity.

By determining the orientation, in particular the angle alignment, of the acquired object, which is now to be classified, in advance, it is possible to significantly reduce the computational complexity for checking similarity using the normalized cross correlation analysis. A conventional method for determining the object orientation includes the evaluation of a Fourier Mellin transform in a polar coordinate system. However, this evaluation is also computationally intensive and can exhibit noticeable inaccuracies and unreliability in the case of more complex shaped objects. Other known Fourier-based approaches are generally also carried out computationally with complicated floating point-based algorithms, since an image or image region in these transforms is projected from the positive spatial dimension into the inverse Fourier space between 0 and 1.

### SUMMARY

A method for image processing is provided. The method includes acquiring at least one object in a recorded image, determining an orientation of the at least one acquired object, and classifying at least one acquired object, the orientation of which was determined, by comparison with a reference. The orientation is determined by calculating at least one moment of inertia of the acquired object.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a flowchart of the method with an associated device;

FIG. 2 shows an image recorded by means of the method from FIG. 1; and

FIGS. 3 to 5 show the recorded image after successive processing by different method steps of the method from FIG. 1.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments at least partly overcome the disadvantages of the prior art and, for example, provide an improved option for classifying objects, e.g. persons who were observed by a camera. Various embodiments provide a computationally simpler option for determining an orientation of an object to be classified.

Various embodiments provide a method for image processing, in which at least one object is acquired in a recorded image, an orientation of the at least one acquired object is determined and at least one acquired object, the orientation of which was determined, is classified by comparison with a reference. The orientation is determined by calculating at least one moment of inertia of the acquired object.

This method may be efficient in the spatial orientation of the acquired object, and hence also an object classification, can be calculated efficiently and, compared to Fourier-based methods, with little outlay.

The image is, for example, an image recorded in the visible spectrum, as a result of which there is a high resolution compared to an infrared image recording, simplifying an object recognition significantly. The image typically has (m·n) image points arranged in the shape of a matrix. However, alternatively or additionally, an infrared image may be recorded. IR (infrared) detectors with a high image resolution, for example on the basis of GaAs sensors or microbolometer-based sensors, are available, in principle, but still very expensive. Currently, they are mainly used in e.g. FUR (“forward-looking infrared”) cameras or during a thermal inspection of a building.

Acquiring an object is understood to mean, in particular, acquiring an object not belonging to an image background. This can be performed in such a way that the image background is determined and removed from the image. Additionally or alternatively, an object not belonging to the image background may be acquired against the image background. An acquired and released object can also be referred to as “segmented” object. Determining the image background may include a comparison with an image background recorded without the presence of an object as a (background) reference.

By way of example, that pixel group which differs or stands out from a predetermined background can initially be treated as an unidentified object during the object acquisition. Then an attempt is made to recognize each one of these acquired objects by the classification, e.g. in a successive manner.

An orientation is understood to mean a spatial orientation of the object. In the case of the two-dimensional recording, the spatial orientation corresponds, for example, to an orientation or alignment in an image plane associated with the image.

In the case of a known orientation, the latter can be used to align the orientation of the acquired object to an orientation of the reference (e.g. of a reference image) with little computational outlay. By way of example, this can be achieved by virtue of the object acquired against the background being rotated into a position suitable for a comparison with the reference or the reference accordingly being rotated toward the orientation of the object.

This object can be classified by the reference after aligning the orientations. If a sufficiently high correspondence with a reference is found, properties of the reference can be assigned to the object. It is then classified or recognized. If the object cannot be classified it is not recognized either. Thus, object recognition is achieved by the classification. Classification and object recognition can also be used synonymously. By way of example, the classification or object recognition can mean that there is recognition as to whether an object is a person or an animal.

One embodiment is such that a centroid of the acquired object is determined. As a result, both a calculation of the at least one moment of inertia and a rotation of the object are simplified. Calculating the centroid is based on evaluating the first order moments. The centroid (xs; ys) is a characteristic object variable, which uniquely sets the position of the object in the image.

From a calculation point of view, the calculation of the centroid of an (N×N) image point matrix By, singled out in an exemplary manner, can be established from an x-coordinate xs of the centroid in accordance with eq. (1):

$$xs = \frac{1}{Qsum} \cdot {\sum }_{xi = 0}^{N - 1} {\sum }_{yj = 0}^{N - 1} {B}_{xi , yj} \cdot xi$$

and from a y-coordinate ys of the centroid in accordance with eq. (2):

$$ys = \frac{1}{Qsum} \cdot {\sum }_{xi = 0}^{N - 1} {\sum }_{yj = 0}^{N - 1} {B}_{xi , yj} \cdot yj$$

with the so-called “overall weight” Qsum of the object in accordance with eq. (3):

$$Qsum = {\sum }_{xi = 0}^{N - 1} {\sum }_{yj = 0}^{N - 1} {B}_{xi , yj}$$

with little computational outlay.

Another embodiment is such that the orientation of the acquired object is determined by the calculation of at least one moment of inertia of the acquired object in the centroid system thereof. The fact that at least one of the moments of inertia is generally related to a main figure axis of the object to be classified (e.g. a longitudinal axis of a human body or a transverse axis in a top view of a human body) is exploited here.

A further embodiment is such that three moments of inertia of the object acquired in a two-dimensional image plane are determined in the centroid system of the object, namely the vertical and horizontal moments of inertia Txx and Tyy and a product of inertia Txy or Tyx in a tensor-based approach. The values of these three moments of inertia Txx, Tyy and Txy are initially dependent on the arbitrarily selected alignment of the object at the outset or on the actually measured alignment of the object in the coordinate system of the image or the image matrix.

In the case of a predetermined object alignment, the three moments of inertia for the object can be calculated with little computational outlay as set forth below, specifically a first moment of inertia Txx in accordance with eq. (4):

$$Txx = \frac{1}{Qsum} \cdot {\sum }_{xi = 0}^{N - 1} {\sum }_{yj = 0}^{N - 1} {B}_{xi , yj} \cdot {( xi - xs )}^{2} ,$$

a second moment of inertia Tyy in accordance with eq. (5):

$$Tyy = \frac{1}{Qsum} \cdot {\sum }_{xi = 0}^{N - 1} {\sum }_{yj = 0}^{N - 1} {B}_{xi , yj} \cdot {( yi - ys )}^{2} ,$$

and a product of inertia Txy in accordance with eq. (6):

$$\begin{matrix}Txy = Tyx \\ = \frac{1}{Qsum} \cdot {\sum }_{xi = 0}^{N - 1} {\sum }_{yj = 0}^{N - 1} {B}_{xi , yj} \cdot ( xi - xs ) \cdot ( yj - ys ) .\end{matrix}$$

The calculated moments of inertia Txx, Tyy and Txy clearly carry the information about the currently present alignment and orientation of the object, with each change in the alignment (e.g. by rotation) leading to different values of these moments of inertia.

What is now sought after advantageously is that object alignment (also referred to as “target orientation” below without loss of generality) in which the mixed inertia element or product of inertia Txy becomes zero. This target orientation is distinguished by virtue of the two main figure axes of the object in this case always being arranged horizontally or vertically (or parallel to an image edge) in the observed image or in the image matrix, which usually also corresponds to an alignment of the reference.

Consequently, a development is such that the object is rotated until the product of inertia Txy thereof is minimized, e.g. minimized to zero. By way of example, this can be carried out iteratively.

An even further embodiment is such that the acquired object is rotated about an angle φ in an image plane, at which the product of inertia Txy is minimized. A computationally particularly simple embodiment is such that the angle φ is calculated in accordance with the following eq. (7):

$$ϕ = a tan [ ( \frac{Txx - Tyy}{2 \cdot Txy} ) - \sqrt{{( \frac{Txx - Tyy}{2 \cdot Txy} )}^{2} + 1} ]$$

since, using this, the object is rotated in one calculation process to a target orientation with Txy=Tyx=0. The rotation is carried out about the centroid determined previously.

Furthermore, an embodiment is such that a color depth of the image is reduced prior to classification. An effect provided thereby is that the image points of the object stand out with a greater contrast against the image surroundings and hence the calculation of the centroid and of the moments of inertia of the object is also simplified. This applies e.g. to the case where a background separation does not provide a sharp contour of the object. In various embodiments, the color depth of the image can be reduced to that of a black/white image, i.e. only having black or white image points. In various embodiments, the object can then only consist of black or white image points and the image surroundings only consist of white or black image points. Thus, for example, what this embodiment brings about is that the acquired binary objects treated by threshold are subsequently analyzed.

The reduction in the color depth may be performed, for example, within the scope, or as a partial step, of the separation of the object from the general image background. Alternatively, it can be carried out e.g. after separating the background in order to simplify the calculation of the centroid and/or of the moments of inertia. Moreover, the result has sufficient significance.

The object is also achieved by a detector (referred to below as “presence detector” without loss of generality), wherein the presence detector includes at least one image sensor, e.g. CMOS sensor, and it is embodied to carry out the method as described above. The presence detector can be embodied analogously to the method and results in the same effects.

The at least one CMOS sensor records images and is coupled to a data processing apparatus, which processes these images within the scope of the method described above. That is to say, the method can be carried out on the data processing apparatus.

Alternatively, the data processing apparatus can constitute a separate unit.

In various embodiments, the presence detector is configured to trigger at least one action depending on a type, position and/or alignment of the classified object, e.g. output at least one signal to switch on an illumination or the like. By way of example, a signal for switching on an illumination may be output after recognizing that the object is a person. Such a signal may not be output if an animal was recognized. Furthermore, if a person was recognized in the vicinity of a door, the door can be opened and an illumination on the other side of the door can be switched on. Furthermore, since the position of the recognized object is known, a light source can be directed onto the object. Alternatively or additionally, an alarm signal can be output to a monitoring unit, e.g. a security center.

By way of example, the presence detector may have a camera (e.g. a video unit) as an image recording apparatus and the data processing apparatus (e.g. a dedicated image data processing unit). The data processing unit switches a switch (e.g. a switch relay) depending on the situation or reports a situation to a light management system.

Various embodiments provide an illumination system or an illumination apparatus, which has at least one presence detector as described above. Here, the presence detector, e.g. the CMOS sensor thereof, is coupled to at least one light source of the illumination system. The data processing apparatus may constitute part of the illumination system, in which case the at least one presence detector, e.g. the CMOS sensor thereof, is coupled to the data processing apparatus of the illumination system.

In various embodiments, the illumination system may be equipped with a plurality of CMOS sensors. This includes the case where the illumination system includes a plurality of cameras or video sensors.

These may have respective data processing apparatuses. Alternatively, a data processing apparatus of the illumination system may be coupled to a plurality of CMOS sensors.

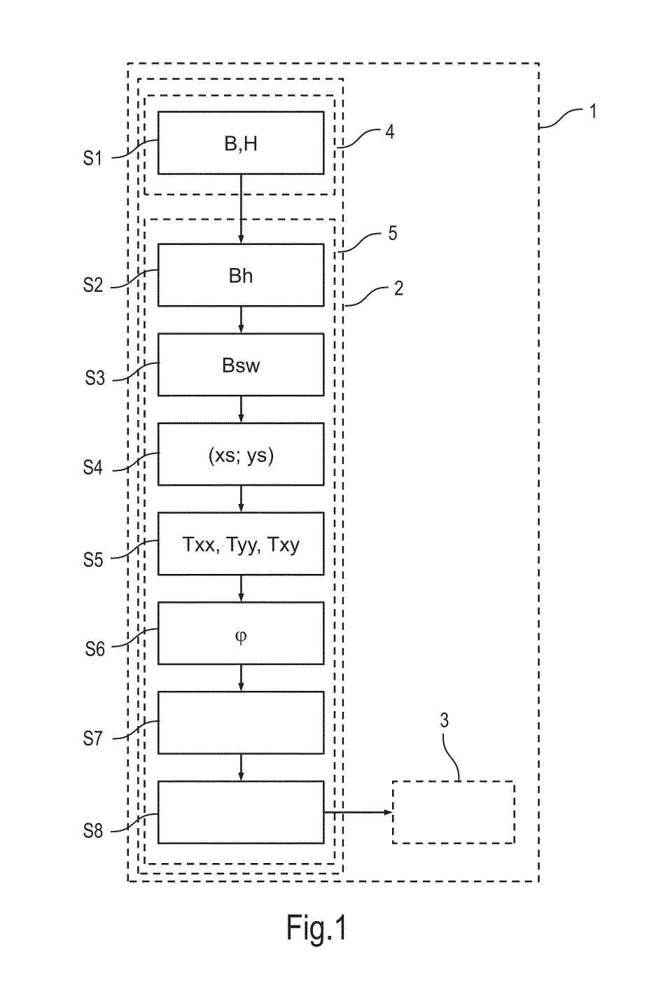

FIG. 1 shows an illumination system 1 with a presence detector 2 and at least one light source 3 (e.g. including one or more LED-based light sources, conventional fluorescent tubes, etc.) coupled to the presence detector 2. The presence detector 2 has a CMOS sensor 4 and a data processing apparatus 5 coupled therewith.

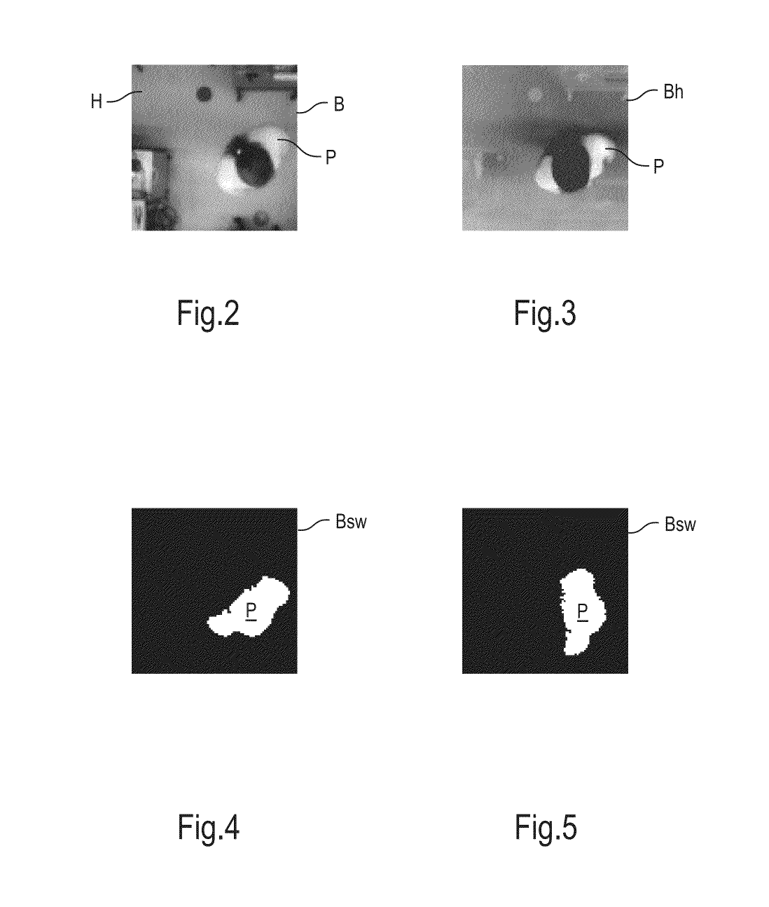

The CMOS sensor 4 is arranged e.g. on a ceiling of a region to be monitored and records an image B of the region, shown in FIG. 2, in S1. This image B shows, in a top view, an object in the form of a person P and a background H which, for example, has shelves.

In S2, the recorded image B is subject to data processing by the data processing apparatus 5 in order to remove the background H. To this end, an appropriate algorithm is applied to the image B. FIG. 3 shows a background-reduced image Bh from the originally recorded image B after applying the algorithm from S2. The background H has receded significantly by virtue of previously visible background objects being largely removed. However, the background H is not completely removed and hence the surroundings of the person P are not completely uniform, but rather irregularities or “residual bits” are still recognizable. Furthermore, the algorithm has slightly smoothed the contrast of the person P.

In S3, a black/white image Bsw is now fabricated from the background-reduced image Bh generated in S2, e.g. by way of a reduction in the color resolution. In this case, the color resolution corresponds to a grayscale resolution due to the original grayscale-value image B. By way of example, the grayscale resolution can be performed by a thresholding operation known per se.

FIG. 4 shows the black/white background-reduced image Bsw. Here, the person P is white throughout and the image region surrounding him/her is completely black. The person P can thus simply be considered to be the white region. Consequently, the person P can be recognized in the recorded image B by S3 or by a combination of S2 and S3.

A centroid (xs; ys) of the person P shown in FIG. 4 is initially calculated in S4, e.g. in accordance with eq. (1) to (3) specified above. Subsequently, the moments of inertia Txx, Tyy and Txy of the person P about their centroid (xs; ys) are calculated in step S5, e.g. in accordance with eq. (4) to (6) specified above. S5 or a combination of S4 and S5 serve to determine the orientation of the person P in the image, which is uniquely provided by the moments of inertia Txx, Tyy and Txy.

For classifying the person P, the person P is rotated through an angle φ about their centroid (xs; ys) in the image plane in a subsequent step S6, e.g. in accordance with eq. (7).

As a result, the person P or their longitudinal axis identified by the moments of inertia Txx or Tyy is aligned parallel to an image side, in this case: parallel to a right or left side edge.

In this target orientation, the aligned person P can be compared with little computational outlay to a reference (e.g. a reference object or a reference image; not shown in the figures) in S7.

By way of example, this can be brought about by means of a normalized cross correlation. In this way, the person P can be identified as a human person in this case.

In S8 at least one action can be triggered, e.g. the at least one light source 3 can be activated, depending on e.g. the type of identified person P, their original alignment and/or their position in the image B. By way of example, since the position of the recognized person P is known by determining their centroid (xs; ys), a light source can be directed to the position for illumination purposes.

Although the invention was described and illustrated more closely in detail by the shown embodiments, the invention is not restricted thereto and other variations can be derived therefrom by a person skilled in the art without departing from the scope of protection of the invention.

For example, it may be the case that the data processing apparatus 5 is not part of the presence detector either, but rather it is part of the illumination system 1. The illumination system 1 may also include a plurality of CMOS sensors.

In general, “a”, “one”, etc. can be understood to mean the singular or the plural, particularly within the meaning of “at least one” or “one or more”, etc., provided this is not explicitly precluded, e.g. by the expression “exactly one”, etc.

Furthermore, a specified number may include precisely the specified number and a conventional tolerance range, provided this is not explicitly precluded.

In general, a region may also be monitored by a plurality of CMOS sensors. Then, it is possible, for example, also to record three-dimensional or stereoscopic images. The method can also be applied to such three-dimensional images, e.g. by calculating the centroid (xs; ys; zs) and three body main axes by the six moments of inertia Txx, Tyy, Tzz, Txy, Txz and Tyz.

### LIST OF REFERENCE SIGNS

1 Illumination system
2 Presence detector
3 Light source
4 CMOS sensor
5 Data processing apparatus
B Recorded image
Bh Background-reduced image
Bsw Black/white image
H Background image
P Person
S1-S8 Method features
Txx First moment of inertia in the x-direction
Tyy Second moment of inertia in the y-direction
Txy Product of inertia
xs x-coordinate of the centroid
ys y-coordinate of the centroid
φ Angle of rotation

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for image processing, the method comprising:
acquiring at least one object in a recorded image;
determining an orientation of the at least one acquired object; and
classifying at least one acquired object, the orientation of which was determined, by comparison with a reference;
wherein the orientation is determined by calculating at least one moment of inertia of the acquired object.

2. The method of claim 1,
wherein a centroid of the acquired object is determined and the orientation of the acquired object is determined by the calculation of at least one moment of inertia of the acquired object in the centroid system thereof.

3. The method of claim 1,
wherein three moments of inertia of the object acquired in an image plane are determined.

4. The method of claim 3,
wherein the acquired object is rotated until a product of inertia is minimized.

5. The method of claim 4,
wherein the acquired object is rotated about an angle in an image plane, with
$$ϕ = a tan [ ( \frac{Txx - Tyy}{2 \cdot Txy} ) - \sqrt{{( \frac{Txx - Tyy}{2 \cdot Txy} )}^{2} + 1} ] .$$

6. The method of claim 1,
wherein an image background is determined and removed from the image for acquiring the at least one object in the image.

7. The method of claim 1,
wherein a color depth of the image is reduced prior to classification.

8. The method of claim 7,
wherein a color depth of the image is reduced prior to classification to a black/white image.

9. The method of claim 1,
wherein the classification is carried out by a normalized cross correlation analysis.

10. A presence detector, comprising:
at least one image sensor;
wherein the at least one image sensor is configured to carry out a method for image processing, the method comprising:
acquiring at least one object in a recorded image;
determining an orientation of the at least one acquired object; and
classifying at least one acquired object, the orientation of which was determined, by comparison with a reference;
wherein the orientation is determined by calculating at least one moment of inertia of the acquired object.

11. The presence detector of claim 10,
wherein the at least one image sensor comprises at least one CMOS sensor.

12. An illumination system, comprising:
at least one light source; and
at least one presence detector, comprising:
at least one image sensor;
wherein the at least one image sensor is configured to carry out a method for image processing, the method comprising:
acquiring at least one object in a recorded image;
determining an orientation of the at least one acquired object; and
classifying at least one acquired object, the orientation of which was determined, by comparison with a reference;
wherein the orientation is determined by calculating at least one moment of inertia of the acquired object;
wherein the at least one presence detector is coupled to the at least one light source.
